(19) United States
(12) Patent Application Publication
(10) Pub. No.: US 2005/0270390 A1
(43) Pub. Date: Dec. 8, 2005

(54) Solid-state image pickup apparatus, solid-state image sensor chip and package

(75) Inventor: Shigeru Hosokai, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/141,006

(22) Filed: Jun. 1, 2005

(30) Foreign Application Priority Data
Jun. 4, 2004 (JP) 2004-166931

(51) Int. Cl. H04N 5/335

(52) U.S. Cl. 348/294

(57) ABSTRACT

A solid-state image pickup apparatus comprises a solid-state image sensor chip contained in a package. The solid-state image sensor chip has a first pad electrode arranged on one side edge and a second pad electrode arranged on another side edge, the first pad electrode and the second pad electrode being connected by interconnections in the package. By using the package interconnections, the interconnections in the chip can be simplified and the chip size can be reduced.

### BACKGROUND OF THE INVENTION

1. Field of the Invention

The present invention relates to a solid-state image pickup apparatus, a solid-state image sensor chip and a solid-state image sensor package. In particular, the present invention relates to techniques for simplifying chip interconnections in a solid-state image sensor and making the chip smaller.

Priority is claimed on Japanese Patent Application No. 2004-166931, filed Jun. 4, 2004, the content of which is incorporated herein by reference.

2. Description of Related Art

It is known that a solid-state image pickup apparatus has horizontal scanning circuits which are located at opposing sides of a light-receiving area. In such type of a conventional solid-state image pickup apparatus, a common signal is applied to the horizontal scanning circuits on each side. In the conventional solid-state image pickup apparatus, as described for example in Japanese Unexamined Patent Application, First Publication, No. H06-339072, the common signal is input to the scanning circuits from a single-pad electrode via interconnections inside a chip.

FIG. 7 is a diagram of the conventional solid-state image pickup apparatus in which the two horizontal scanning circuits are separately located. In FIG. 7, charge modulation devices (CMDs) 10-11, 10-12, . . . 10-34 which form pixels, respectively, and are arranged in a matrix. The rows of CMDs arranged in the X direction are commonly connected by horizontal selection wires 11-1, 11-2 and 11-3, respectively, in which a vertical scanning circuit 12 outputs to each of the horizontal selection wires 11-1, 11-2 and 11-3. The rows of CMDs arranged in the Y direction are connected to vertical selection wires 13-1, 13-2, 13-3 and 13-4, respectively. The vertical selection wires 13-1 and 13-3 are connected to an output line 15-1 via MOS switches 14-1 and 14-3, respectively, for reading data. Similarly, the vertical selection wires 13-2 and 13-4 are connected to an output line 15-2 via MOS switches 14-2 and 14-4, respectively, for reading data. Output pulses Φ1-1 and Φ1-3 from a first horizontal scanning circuit 16-1 are applied to gates of the MOS switches 14-1 and 14-3, and output pulses Φ1-2 and Φ1-4 from a second horizontal scanning circuit 16-2 are applied to gates of the MOS switches 14-2 and 14-4.

This solid-state image pickup apparatus is provided with a pad 17 for applying common input pulses to the first and second horizontal scanning circuits 16-1 and 16-2. The input pulses applied to the pad 17 are supplied to the first and second horizontal scanning circuits 16-1 and 16-2 via a first buffer 18 and second buffers 19-1 and 19-2.

While, in the above example, the horizontal scanning circuits are separately provided at opposing sides of the light-receiving area, the vertical scanning circuit may also be separately provided at opposing sides of the light-receiving area. When the vertical scanning circuits are divided or separately provided, a pad for applying common input pulses to the first and second horizontal scanning circuits, and a pad for applying common input pulses to first and second vertical scanning circuits, are to be provided.

In the solid-state image pickup apparatus in which horizontal scanning circuits and vertical scanning circuits are divided or separately provided as mentioned above, the common input signal is sometimes input to the horizontal scanning circuits or the vertical scanning circuits provided on both sides. Conventionally, the single pad electrode is provided for the common signal and, thereby, the common signal is supplied from the single pad electrode to the scanning circuits. When applying the same signal to multiple circuit units in this way, inputting the common signal from the single pad electrode restricts any increase in the number of pad electrodes and prevents the solid-state image pickup apparatus from increasing in size.

### SUMMARY OF THE INVENTION

According to a first aspect of the present invention, a solid-state image pickup apparatus comprises a solid-state image sensor chip contained in a package. The solid-state image sensor chip has a first pad electrode arranged on one side edge and a second pad electrode arranged on the other side edge, the first pad electrode and the second pad electrode being connected by interconnections in the package.

According to a second aspect of the present invention, in the first aspect, the first and second pad electrodes are arranged at mutually opposing positions and function according to an identical signal.

According to a third aspect of the present invention, in the first and second aspects, the package has at its peripheries external terminals that connect to interconnections in the package and also connect to external devices. The external terminals are arranged along a first outer periphery and a second outer periphery of the package, facing the side edge and the other side edge, respectively.

According to a fourth aspect of the present invention, in the third aspect, regarding the corresponding first pad electrode and the second pad electrode as one unit, the external terminals are alternately arranged on the first outer periphery and the second outer periphery for every unit.

According to a fifth aspect of the present invention, a solid-state image sensor chip comprises a plurality of function units that execute predetermined functions with respect to an image pickup unit, and a plurality of electrode pads connected to the function units. The plurality of electrode pads are arranged along opposing side edges, and the plurality of electrode pads, that are connected to the plurality of function units that function according to an associated one of the identical signals, are arranged along approximately identical lines.

According to a sixth aspect of the present invention, a package holds a solid-state image sensor chip that comprises a plurality of function units that execute predetermined functions with respect to an image pickup unit, and a plurality of electrode pads connected to the function units. The plurality of electrode pads are arranged along opposing side edges, and the plurality of electrode pads, that are connected to the plurality of function units that function according to an associated one of identical signals, are arranged along approximately identical lines. Interconnections are provided to connect the first electrode pad and the second electrode pad that function according to an associated one of the identical signals, among the pad electrodes arranged on the side edge and the pad electrodes arranged on the other side edge.

According to a seventh aspect of the present invention, in the sixth aspect, the package further comprises, around its outer peripheries, external terminals that connect to the interconnections and also connect to external devices. The external terminals are arranged along a first outer periphery and a second outer periphery of the package, facing the side edge and the other side edge respectively.

According to an eighth aspect of the present invention, in the seventh aspect, regarding the corresponding first pad electrode and the second pad electrode as one unit, the external terminals are alternately arranged on the first outer periphery and the second outer periphery for every unit.

### BRIEF DESCRIPTION OF THE DRAWINGS

FIG. 1 is a perspective view used in an explanation of package interconnections in a solid-state image pickup apparatus;

FIG. 2 is a cross-sectional view taken along line A-A′ of FIG. 1, used in an explanation of package interconnections in a solid-state image pickup apparatus

FIG. 3 is a diagram showing the constitution of a solid-state image pickup apparatus according to a first embodiment of the present invention;

FIG. 4 is a diagram showing the constitution of a solid-state image pickup apparatus according to a second embodiment of the present invention;

FIG. 5 is a diagram showing the constitution of a solid-state image pickup apparatus according to a third embodiment of the present invention;

FIG. 6 is a diagram showing the constitution of a solid-state image pickup apparatus according to a fourth embodiment of the present invention; and

FIG. 7 is a connection diagram used in an explanation of a conventional solid-state image pickup apparatus.

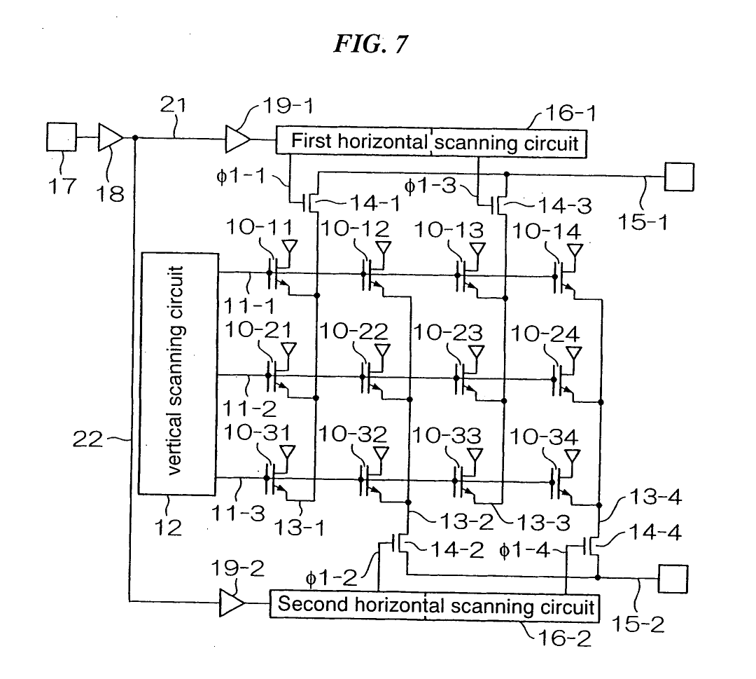

### DETAILED DESCRIPTION OF THE INVENTION

Embodiments of the present invention will now be explained in reference to the drawings. The embodiments of the present invention use package interconnections to form signal wires for inputting a common signal in a solid-state image pickup apparatus.

The package interconnections mean interconnections in a package that contains a solid-state image sensor chip. Before describing embodiments of the present invention, the package interconnections will first be explained.

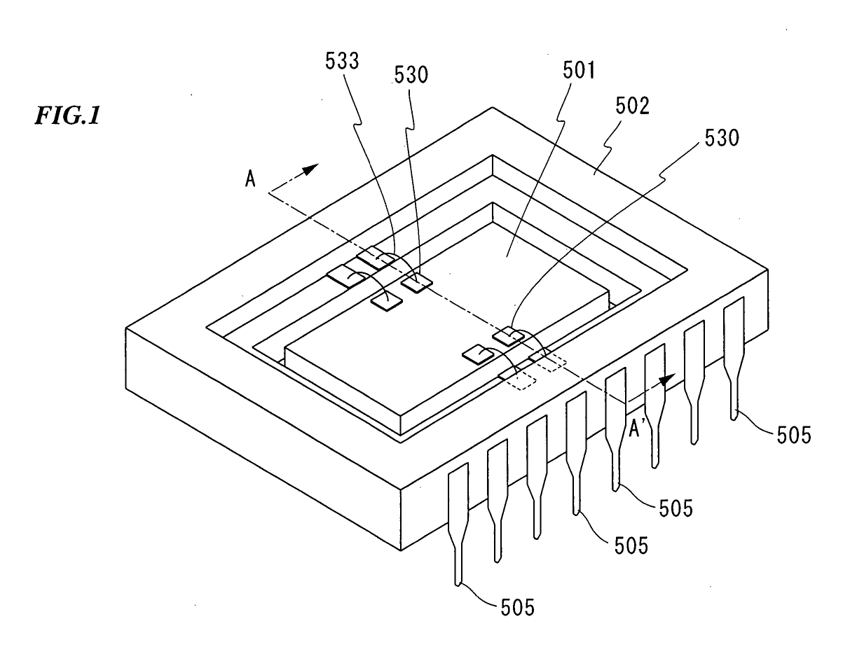

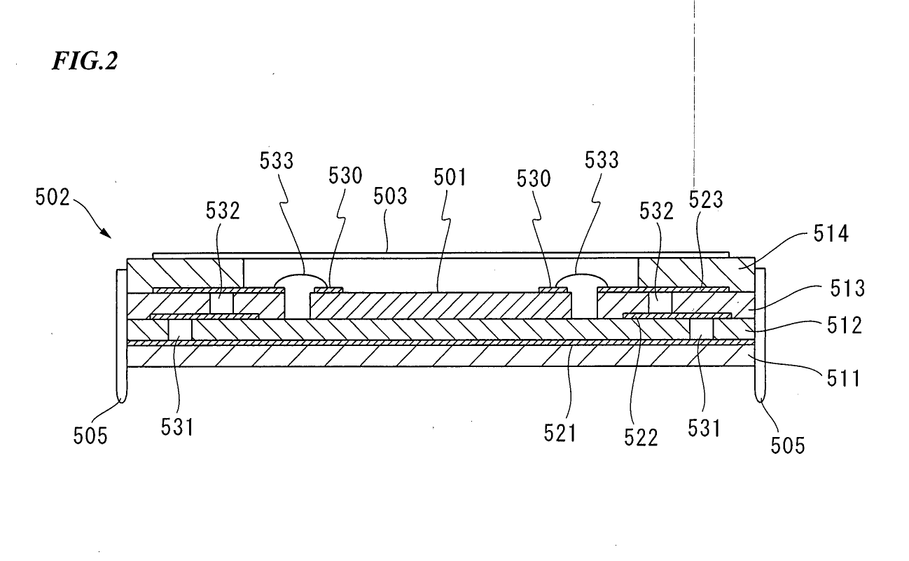

As shown in FIG. 1, a solid-state image pickup apparatus includes a package 502 that contains a solid-state image sensor chip 501. As shown in FIG. 2, a cross-sectional view taken along line A-A of FIG. 1, the package 502 comprises, for example, four package layers 511, 512, 513 and 514. The solid-state image sensor chip 501 is arranged on the package 502. The uppermost part of the package 502 is sealed by a transparent member 503 made of glass or the like. External terminals 505 lead from the package 502. FIGS. 1 and 2 are schematic representation of the package interconnections, and do not depict the actual interconnections.

An interconnection 521 is formed between the first package layer 511 and the second package layer 512. An interconnection 522 is formed between the second package layer 512 and the third package layer 513. An interconnection 523 is formed between the third package layer 513 and the fourth package layer 514.

A pad electrode 530 is arranged on the solid-state image sensor chip 501. The pad electrode 530 of the solid-state image sensor chip 501 is connected by a connection unit 533, such as wire bonding, to the interconnection 523 between the third package layer 513 and the fourth package layer 514.

An interlayer contact 532 connects the interconnection 523 between the third package layer 513 and the fourth package layer 514 to the interconnection 522 between the second package layer 512 and the third package layer 513. An interlayer contact 531 connects the interconnection 522 between the second package layer 512 and the third package layer 513 to the interconnection 521 between the first package layer 511 and the second package layer 512. The interconnection 521 between the first package layer 511 and the second package layer 512 connects to the associated external terminals 505, 505. Thus the package interconnections use the interconnections 521, 522 and 523 between the package layers, the interlayer contacts 531 and 532, and the connection unit 533. As described below, this invention uses such package interconnections as signal wires for inputting a common signal.

Interlayer interconnections, such as the interconnections 521, 522 and 523 between the package layers 511, 512, 513 and 514, may be used as package interconnections of this invention. Furthermore, while this example has four package layers, there is of course no restriction on this. The connections between the pad electrode of the solid-state image sensor chip 501 and the interconnections in the package are not restricted to wire bonding. While the above example includes a lead-type external terminal 505, there is no restriction on this.

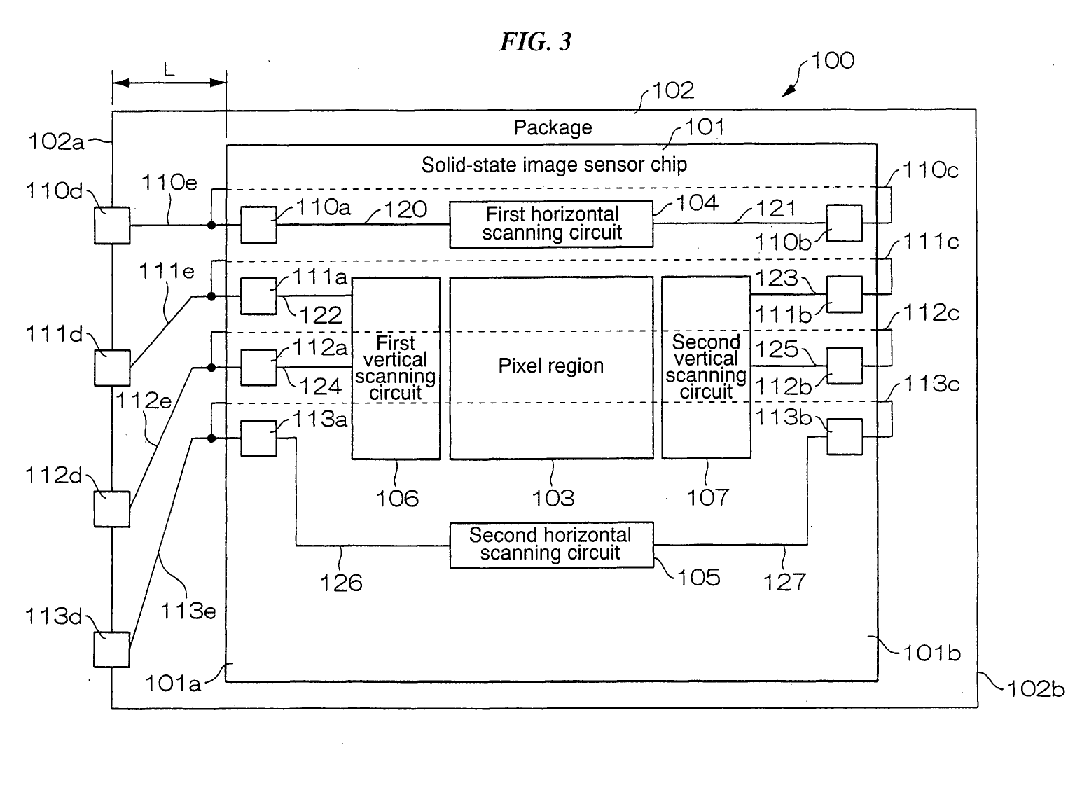

FIG. 3 is a schematic view of a solid-state image pickup apparatus 100 according to an embodiment of this invention. In FIG. 3, a solid-state image sensor chip 101 of the solid-state image pickup apparatus 100 is contained in a package 102. A pixel region 103 is formed on the solid-state image sensor chip 101. A first horizontal scanning circuit 104, a second horizontal scanning circuit 105, a first vertical scanning circuit 106, and a second vertical scanning circuit 107, are provided on the solid-state image sensor chip 101 on either side of the pixel region 103. In the schematic diagram of this embodiment, pad electrodes 110a, 10b, 111a, 111b, 112a, 112b, 113a and 113b, correspond to the pad electrode 530 of FIG. 2, and package interconnections 110c, 110e, 111c, 111e, 112c, 112e, 113c and 113e, correspond to the package interconnections 521, 522 and 523, the interlayer contacts 531 and 532, and the connection unit 533 of FIG. 2.

The pad electrodes 110a, 111a, 112a and 113a, are formed on one side edge 101a of the solid-state image sensor chip 101, and the pad electrodes 110b, 111b, 112b and 113b, are formed on another side edge 101b. A chip interconnection 120 connects the pad electrode 110a to the first horizontal scanning circuit 104. A chip interconnection 121 connects the pad electrode 110b to the first horizontal scanning circuit 104. A chip interconnection 122 connects the pad electrode 111a to the first vertical scanning circuit 106. A chip interconnection 123 connects the pad electrode 111b to the second vertical scanning circuit 107. A chip interconnection 124 connects the pad electrode 112a to the first vertical scanning circuit 106. A chip interconnection 125 connects the pad electrode 112b to the second vertical scanning circuit 107. A chip interconnection 126 connects the pad electrode 113a to the second horizontal scanning circuit 105. A chip interconnection 127 connects the pad electrode 113b to the second horizontal scanning circuit 105.

The pad electrode 110a and the pad electrode 110b are electrodes for inputting identical signals. The pad electrode 110a and the pad electrode 110b are connected by the package interconnection 110c. The pad electrode 111a and the pad electrode 111b are electrodes for inputting identical signals. The pad electrode 111a and the pad electrode 111b are connected by the package interconnection 111c. The pad electrode 112a and the pad electrode 112b are electrodes for inputting identical signals. The pad electrode 112a and the pad electrode 112b are connected by the package interconnection 112c. The pad electrode 113a and the pad electrode 113b are electrodes for inputting identical signals. The pad electrode 113a and the pad electrode 113b are connected by the package interconnection 113c.

Thus the pad electrodes 110a and 110b, 111a and 111b, 112a and 112b, and 113a and 113b, are respectively arranged along approximately identical lines at approximately opposite positions on opposing side edges so as to input identical signals. The pad electrodes 110a and 110b, 111a and 111b, 112a and 112b, and 113a and 113b, that input identical signals, are respectively connected by the package interconnections 110c, 111c, 112c and 113c.

The outer periphery 102a of the package 102 faces the side edge 101a of the solid-state image sensor chip 101, and the outer periphery 102b of the package 102 faces the side edge 101b of the solid-state image sensor chip 101. External terminals 110d, 111d, 112d and 113d, are provided along one outer periphery 102a of the package 102. The package interconnections 110c, 111c, 112c and 113c are respectively connected to the external terminals 110d, 111d, 112d and 113d, by the package interconnections 110e, 111e, 112e and 113e.

Thus, in the first embodiment, the pad electrodes 110a and 110b, 111a and 111b, 112a and 112b, and 113a and 113b, are respectively arranged at approximately opposite positions on opposing side edges so as to input identical signals. The pad electrodes 110a and 110b that input identical signals are connected to the external terminal 110d by the package interconnections 110c and 110e, the pad electrodes 111a and 111b that input identical signals are connected to the external terminal 111d by the package interconnections 111c and 111e, the pad electrodes 112a and 112b that input identical signals are connected to the external terminal 112d by the package interconnections 112c and 112e, and the pad electrodes 113a and 113b that input identical signals are connected to the external terminal 113d by the package interconnections 113c and 113e. Since identical signals are input to the pad electrodes 110a and 110b, 11a and 111b, 112a and 112b, and 113a and 113b, arranged at approximately opposite positions on opposing side edges, it is no longer necessary to use chip interconnections to connect the pad electrodes that input identical signals inside the solid-state image sensor chip. This makes it possible to reduce the number of interconnection regions of the chip, and reduce the area of the solid-state image sensor chip.

Subsequently, a second embodiment of this invention will be explained.

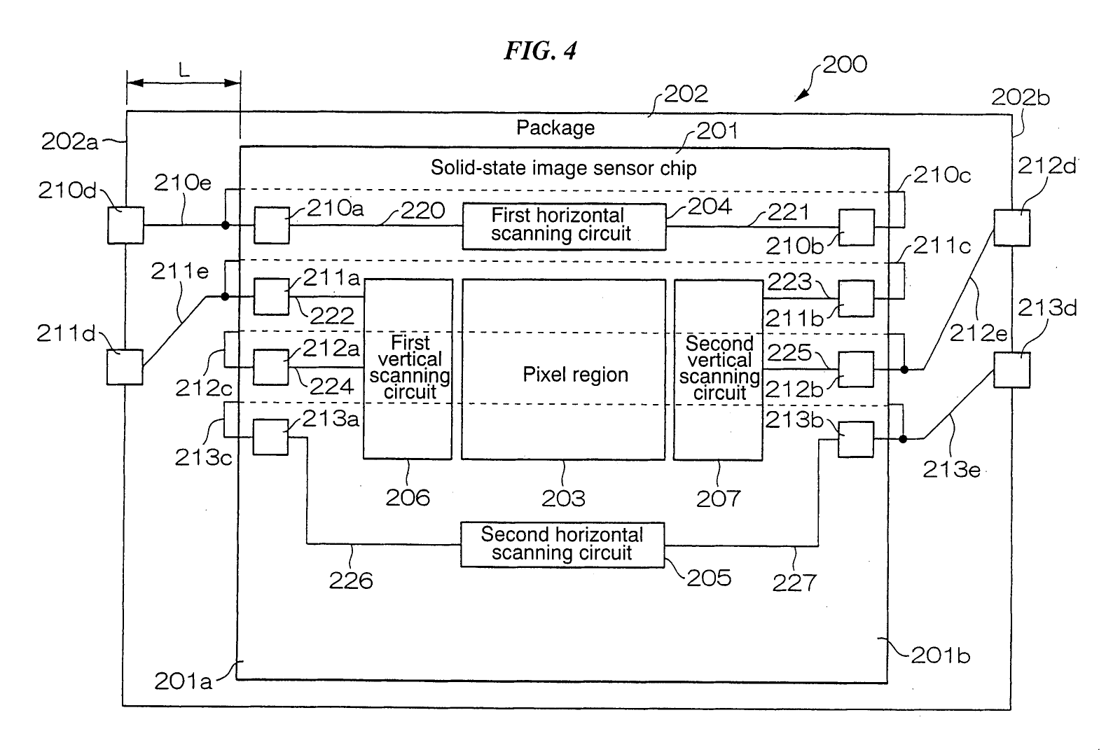

FIG. 4 is a general view of a solid-state image pickup apparatus 200 according to the second embodiment of this invention. In FIG. 4, a solid-state image sensor chip 201 of the solid-state image pickup apparatus 200 is contained in a package 202. A pixel region 203 is formed on the solid-state image sensor chip 201. A first horizontal scanning circuit 204, a second horizontal scanning circuit 205, a first vertical scanning circuit 206, and a second vertical scanning circuit 207, are provided on the solid-state image sensor chip 201 on either side of the pixel region 203. In the schematic diagram of this embodiment, pad electrodes 210a, 210b, 211a, 211b, 212a, 212b, 213a and 213b, correspond to the pad electrode 530 of FIG. 2, and package interconnections 210c, 210e, 211c, 211e, 212c, 212e, 213c and 213e, correspond to the package interconnections 521, 522 and 523, the interlayer contacts 531 and 532, and the connection unit 533 of FIG. 2.

The pad electrodes 210a, 211a, 212a and 213a are formed on one side edge 201a of the solid-state image sensor chip 201, and the pad electrodes 210b, 211 b, 212b and 213b are formed on another side edge 201b. A chip interconnection 220 connects the pad electrode 210a to the first horizontal scanning circuit 204. A chip interconnection 221 connects the pad electrode 210b to the first horizontal scanning circuit 204. A chip interconnection 222 connects the pad electrode 211a to the first vertical scanning circuit 206. A chip interconnection 223 connects the pad electrode 211b to the second vertical scanning circuit 207. A chip interconnection 224 connects the pad electrode 212a to the first vertical scanning circuit 206. A chip interconnection 225 connects the pad electrode 212b to the second vertical scanning circuit 207. A chip interconnection 226 connects the pad electrode 213a to the second horizontal scanning circuit 205. A chip interconnection 227 connects the pad electrode 213b to the second horizontal scanning circuit 205.

The pad electrode 210a and the pad electrode 210b are electrodes for inputting identical signals. The pad electrode 210a and the pad electrode 210b are connected by the package interconnection 210c. The pad electrode 211a and the pad electrode 211b are electrodes for inputting identical signals. The pad electrode 211a and the pad electrode 211b are connected by the package interconnection 211c. The pad electrode 212a and the pad electrode 212b are electrodes for inputting identical signals. The pad electrode 212a and the pad electrode 212b are connected by the package interconnection 212c. The pad electrode 213a and the pad electrode 213b are electrodes for inputting identical signals. The pad electrode 213a and the pad electrode 213b are connected by the package interconnection 213c.

Thus the pad electrodes 210a and 210b, 211a and 211b, 212a and 212b, and 213a and 213b, are respectively arranged along approximately identical lines at approximately opposite positions on opposing side edges so as to input identical signals. The pad electrodes 210a and 210b, 211a and 211b, 212a and 212b, and 213a and 213b, that input identical signals, are respectively connected by the package interconnections 210c, 211c, 212c, and 213c.

The outer periphery 202a of the package 202 faces the side edge 201a of the solid-state image sensor chip 201, and the outer periphery 202b of the package 202 faces the side edge 201b of the solid-state image sensor chip 201. External terminals 210d and 211d are provided along one outer periphery 202a of the package 202, and external terminals 212d and 213d are provided along the other outer periphery 202b of the package 202. The package interconnections 210c, 211c, 212c and 213c are respectively connected to the external terminals 210d, 211d, 212d and 213d, by the package interconnections 210e, 211e, 212e and 213e.

The second embodiment differs from the first embodiment in that, in the first embodiment, a plurality of external terminals are all provided along one side edge of the package, whereas in the second embodiment, the plurality of external terminals are divided on opposing outer peripheries of the package. That is, in the second embodiment, the external terminals 212d and 213d are provided on the other outer periphery 202b of the package 202.

When there is a great number of input signals (i.e. pad electrodes), the pitch between the external terminals is normally wider than the pitch between pad electrodes; package interconnections for connecting to the external terminals must therefore be routed, consequently increasing the size of the package for establishing these interconnection regions. According to this embodiment, the area of the package interconnection regions for connecting to the external terminals can be reduced by dividing the external terminals on the opposing outer peripheries of the package. This enables the interval L between the chip end and the package end to be made narrower than that of the first embodiment, so that the outer shape of the package can be made smaller.

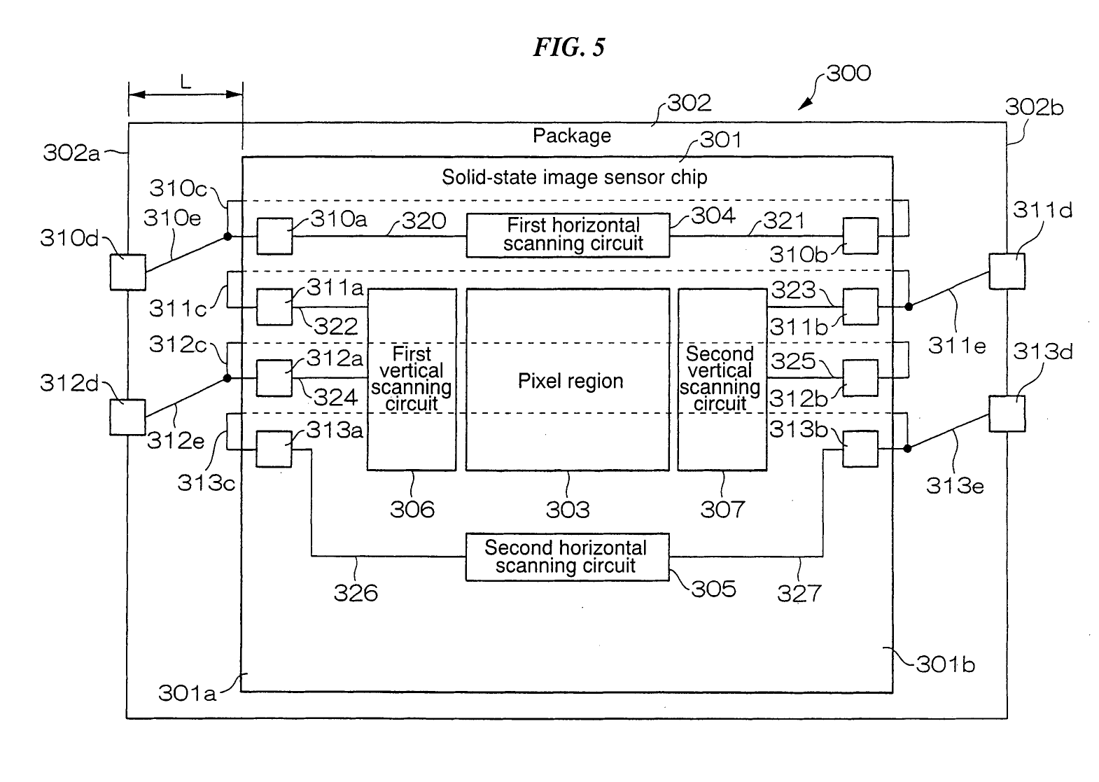

FIG. 5 is a diagram showing a solid-state image pickup apparatus 300 according to a third embodiment of this invention. A solid-state image sensor chip 301 of the solid-state image pickup apparatus 300 is contained in a package 302. A pixel region 303 is formed on the solid-state image sensor chip 301. A first horizontal scanning circuit 304, a second horizontal scanning circuit 305, a first vertical scanning circuit 306, and a second vertical scanning circuit 307 are provided on the solid-state image sensor chip 301 on either side of the pixel region 303. In the schematic diagram of this embodiment, pad electrodes 310a, 310b, 311a, 311b, 312a, 312b, 313a and 313b correspond to the pad electrode 530 of FIG. 2, and package interconnections 310c, 310e, 311c, 311e, 312c, 312e, 313c and 313e correspond to the package interconnections 531, 522 and 523, the interlayer contacts 531 and 532, and the connection unit 533 of FIG. 2.

The pad electrodes 311a, 311a, 312a and 313a are formed on one side edge 301a of the solid-state image sensor chip 301, and the pad electrodes 310b, 311b, 312b and 313b are formed on another side edge 301b. A chip interconnection 320 connects the pad electrode 310a to the first horizontal scanning circuit 304. A chip interconnection 321 connects the pad electrode 310b to the first horizontal scanning circuit 304. A chip interconnection 322 connects the pad electrode 311a to the first vertical scanning circuit 306. A chip interconnection 323 connects the pad electrode 311b to the second vertical scanning circuit 307. A chip interconnection 324 connects the pad electrode 312a to the first vertical scanning circuit 306. A chip interconnection 325 connects the pad electrode 312b to the second vertical scanning circuit 307. A chip interconnection 326 connects the pad electrode 313a to the second horizontal scanning circuit 305. A chip interconnection 327 connects the pad electrode 313b to the second horizontal scanning circuit 305.

The pad electrode 310a and the pad electrode 310b are electrodes for inputting identical signals. The pad electrode 310a and the pad electrode 310b are connected by the package interconnection 310c. The pad electrode 311a and the pad electrode 311b are electrodes for inputting identical signals. The pad electrode 311a and the pad electrode 311b are connected by the package interconnection 311c. The pad electrode 312a and the pad electrode 312b are electrodes for inputting identical signals. The pad electrode 312a and the pad electrode 312b are connected by the package interconnection 312c. The pad electrode 313a and the pad electrode 313b are electrodes for inputting identical signals. The pad electrode 313a and the pad electrode 313b are connected by the package interconnection 313c.

Thus the pad electrodes 310a and 310b, 311a and 311b, 312a and 312b, and 313a and 313b, are respectively arranged along approximately identical lines at approximately opposite positions on opposing side edges so as to input identical signals. The pad electrodes 310a and 310b, 311a and 311b, 312a and 312b, and 313a and 313b, that input identical signals, are respectively connected by the package interconnections 310c, 311c, 312c, and 313c.

The outer periphery 302a of the package 302 faces the side edge 301a of the solid-state image sensor chip 301, and the outer periphery 302b of the package 302 faces the side edge 301b of the solid-state image sensor chip 301. External terminals 310d and 312d are provided along one outer periphery 302a of the package 302, and external terminals 311d and 313d are provided along the other outer periphery 302b of the package 302. The package interconnections 310c, 311c, 312c and 313c are respectively connected to the external terminals 310d, 311d, 312d and 313d, by the package interconnections 310e, 311e, 312e and 313e.

The third embodiment differs from the second embodiment in that, in the third embodiment, the external terminals and their corresponding pad electrodes are treated as one unit, the external terminals being arranged alternately at every other unit along opposing outer peripheries of the package. That is, in the third embodiment, the external terminal that corresponds to the pad electrode 310a is arranged on one outer periphery 302a of the package 302, the external terminal that corresponds to the pad electrode 311b is arranged on the other outer periphery 302b of the package 302, the external terminal that corresponds to the pad electrode 312a is arranged on one outer periphery 302a of the package 302, and the external terminal that corresponds to the pad electrode 313b is arranged on the other outer periphery 302b of the package 302. Alternately arranging the external terminals at every other unit on opposite outer peripheries of the package in this manner is equivalent to widening the pad electrode pitch, thereby making it easier to route the package interconnections for connecting to the external terminals. Therefore, the interval L between the chip end and the package end can be made even narrower than that of the second embodiment, and the outer shape of the package can be made even smaller.

Subsequently, a fourth embodiment of this invention will be explained.

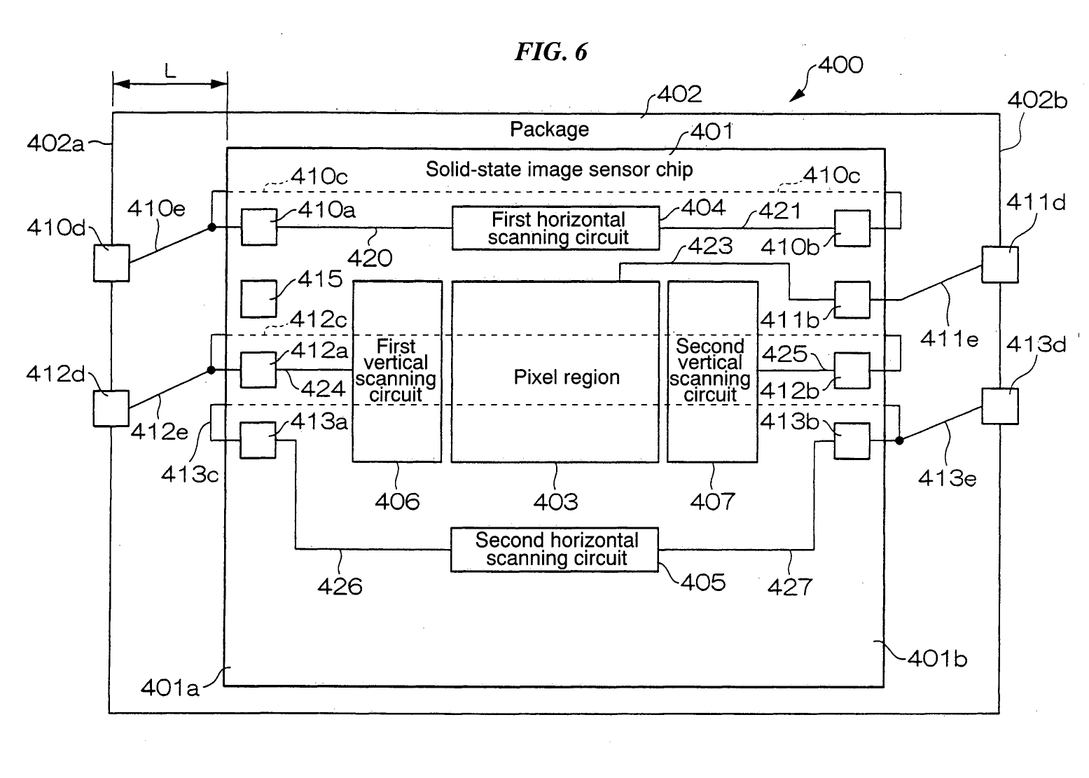

FIG. 6 is a diagram of the constitution of a solid-state image pickup apparatus according to the fourth embodiment. This embodiment describes a case where some of the pad electrodes that are provided on opposing outer peripheries do not need to be commonly connected.

In FIG. 6, a solid-state image sensor chip 401 of a solid-state image pickup apparatus 400 is contained in a package 402. A pixel region 403 is formed on the solid-state image sensor chip 401. A first horizontal scanning circuit 404, a second horizontal scanning circuit 405, a first vertical scanning circuit 406, and a second vertical scanning circuit 407 are provided on the solid-state image sensor chip 401 on either side of the pixel region 403. In the schematic diagram of this embodiment, pad electrodes 410a, 410b, 411b, 412a, 412b, 413a and 413b correspond to the pad electrode 530 of FIG. 2, and package interconnections 410c, 410e, 411e, 412c, 412e, 413c and 413e correspond to the package interconnections 521, 522 and 523, the interlayer contacts 531 and 532, and the connection unit 533 of FIG. 2.

The pad electrodes 410a, 412a, 413a, and a dummy pad electrode 415, are formed on one side edge 401a of the solid-state image sensor chip 401, and the pad electrodes 410b, 411b, 412b and 413b, are formed on another side edge 401b. A chip interconnection 420 connects the pad electrode 410a to the first horizontal scanning circuit 404. A chip interconnection 421 connects the pad electrode 410b to the first horizontal scanning circuit 404. A chip interconnection 424 connects the pad electrode 412a to the first vertical scanning circuit 406. A chip interconnection 425 connects the pad electrode 412b to the second vertical scanning circuit 407. A chip interconnection 426 connects the pad electrode 413a to the second horizontal scanning circuit 405. A chip interconnection 427 connects the pad electrode 413b to the second horizontal scanning circuit 405.

The pad electrode 410a and the pad electrode 410b are electrodes for inputting identical signals. The pad electrode 410a and the pad electrode 410b are connected by the package interconnection 410c. Nothing is supplied to the dummy pad electrode 415. A power source, for example, is supplied as an input signal to the pad electrode 411b. The pad electrode 412a and the pad electrode 412b are electrodes for inputting identical signals. The pad electrode 412a and the pad electrode 412b are connected by the package interconnection 412c. The pad electrode 413a and the pad electrode 413b are electrodes for inputting identical signals. The pad electrode 413a and the pad electrode 413b are connected by the package interconnection 413c.

Thus the pad electrodes 410a and 410b, 412a and 412b, and 413a and 413b, are respectively arranged along approximately identical lines at approximately opposite positions on opposing side edges so as to input identical signals. These pad electrodes that input identical signals are connected by the package interconnections 410c, 412c and 413c respectively. The same signals are not supplied to the pad electrode 411b and the dummy pad electrode 415, and they are not connected by package interconnections.

The outer periphery 402a of the package 402 faces the side edge 401a of the solid-state image sensor chip 401, and the outer periphery 402b of the package 402 faces the side edge 401b of the solid-state image sensor chip 401. External terminals 410d and 412d are provided along one outer periphery 402a of the package 402, and external terminals 411d and 413d are provided along the other outer periphery 402b of the package 402. The package interconnections 410c, 412c and 413c, are respectively connected to the external terminals 410d, 412d and 413d by the package interconnections 410e, 412e and 413e. The pad electrode 411b is connected to the external terminal 411d by a package interconnection 411e.

This embodiment describes a case where the pad electrodes, that are arranged at approximately opposing positions at opposite ends of the solid-state image sensor chip 401, include one that inputs a signal only to the pad electrode on one side. Although the pad electrode 411b and the dummy pad electrode 415 are provided at approximately opposing positions on opposite sides, a signal is supplied only to the pad electrode 411b and not to the dummy pad electrode 415.

Even in a case such as this, where one of the pad electrodes provided on opposite sides does not need to be commonly connected, the solid-state image pickup apparatus can be made smaller by using package interconnections to commonly connect the pad electrodes, and alternately arranging the external terminals connected thereto along opposing outer peripheries of the package.

It goes without saying that it is not always necessary to provide the dummy pad electrode 415, that is not connected to any of the circuits on the solid-state image sensor chip.

While, in all the embodiments of this invention, the signals are supplied to the pad electrodes, commonly connected by package interconnections, by inputting the signals to scanning circuits via chip interconnections, it is not always necessary to input the signals to scanning circuits. As explained above, in all the embodiments of the invention, the package interconnections include means for electrically connecting the pad electrodes on the image pickup sensor chip and the metal interconnections formed on the package, and, while wire bonding or the like is generally used as electrical connection means, any means that obtains an electrical connection with low resistance can be used. As is the case with electrical connection means between the pad electrodes and the package interconnections, the external terminals may be any shape that can obtain an electrical connection at low resistance with an unillustrated external electrical circuit board.

While the above embodiments describe an example of an XY address-type solid-state image pickup apparatus having scanning circuits at its top, bottom, left, and right, sides, there are no restrictions on this.

According to this invention, the area of the solid-state image sensor chip can be reduced.

According to this invention, in addition to the above effect, interconnections in the package can be routed more easily.

According to this invention, the outer shape of the package can be made smaller.

According to this invention, interconnections in the package can be routed more easily.

This invention is not restricted to the embodiments described above, and may be modified and applied in various ways without deviating from its main concepts.

1. A solid-state image pickup apparatus comprising:
a solid-state image sensor chip which is contained in a package and has a first pad electrode arranged on its one side edge and a second pad electrode arranged on its another side edge,
wherein said first pad electrode and said second pad electrode are connected by interconnections in said package.

2. The solid-state image pickup apparatus according to claim 1, wherein said first and second pad electrodes are arranged at mutually opposing positions and function according to an identical signal.

3. The solid-state image pickup apparatus according to claim 2, wherein said package has, around its outer peripheries, external terminals that connect to interconnections in said package and also connect to external devices, said external terminals being arranged along a first outer periphery and a second outer periphery of the package, facing said side edge and said other side edge respectively.

4. The solid-state image pickup apparatus according to claim 3, wherein, regarding the corresponding first pad electrode and the second pad electrode as one unit, said external terminals are alternately arranged on said first outer periphery and said second outer periphery for every unit.

5. The solid-state image pickup apparatus according to claim 1, wherein said package has, around its outer peripheries, external terminals that connect to interconnections in said package and also connect to external devices, said external terminals being arranged along a first outer periphery and a second outer periphery of the package, facing said side edge and said other side edge respectively.

6. The solid-state image pickup apparatus according to claim 5, wherein, regarding the corresponding first pad electrode and the second pad electrode as one unit, said external terminals are alternately arranged on said first outer periphery and said second outer periphery for every unit.

7. A solid-state image sensor chip comprising:
a plurality of function units that execute predetermined functions with respect to an image pickup unit; and
a plurality of electrode pads connected to the function units;
wherein said plurality of electrode pads are arranged along opposing side edges, and the plurality of electrode pads, that are connected to the plurality of function units that function according to an associated one of identical signals, are arranged along approximately identical lines.

8. A package that holds a solid-state image sensor chip, said solid-state image sensor chip comprising a plurality of function units that execute predetermined functions with respect to an image pickup unit, and a plurality of electrode pads connected to the function units; said plurality of electrode pads being arranged along opposing side edges, and the plurality of electrode pads, that are connected to the plurality of function units that function according to an associated one of identical signals, being arranged along approximately identical lines; and
interconnections being provided to connect said first electrode pad and said second electrode pad that function according to said associated one of said identical signals, among said pad electrodes arranged on said side edge and said pad electrodes arranged on said other side edge.

9. The package according to claim 8, further comprising, around its outer peripheries, external terminals that connect to the interconnections and also connect to external devices, wherein said external terminals are arranged along a first outer periphery and a second outer periphery of said package, said first outer periphery and said second outer periphery facing said side edge and said other side edge, respectively.

10. The package according to claim 9, wherein, regarding the corresponding first pad electrode and the second pad electrode as one unit, said external terminals are alternately arranged on said first outer periphery and said second outer periphery for every unit.
